(19) United States
(12) Patent Application Publication
(10) Pub. No.: US 2006/0062249 A1
(43) Pub. Date: Mar. 23, 2006

(54) Apparatus and method for adjusting bandwidth allocation in downhole drilling networks

(76) Inventors: David R. Hall, Provo, UT (US); David S. Pixton, Lehi, UT (US); Monte l. Johnson, Orem, UT (US); David B. Bartholomew, Springville, UT (US); H. Tracy Hall JR., Provo, UT (US); Marshall A. Soares, Taylorsville, UT (US)

Correspondence Address: JEFFREY E. DALY;INTELLISERV, INC, 400 N. SAM HOUSTON PARKWAY EAST, SUITE 900, HOUSTON, TX, 77060, US

(21) Appl. No.: 10/878,145

(22) Filed: Jun. 28, 2004

(51) Int. Cl. H04J 3/22

(52) U.S. Cl. 370/468

(57) ABSTRACT

A high-speed downhole network providing real-time data from downhole components of a drilling strings includes a bottom-hole node interfacing to a bottom-hole assembly located proximate the bottom end of a drill string. A top-hole node is connected proximate the top end of the drill string. One or several intermediate nodes are located along the drill string between the bottom-hole node and the top-hole node. The downhole network is configured to include a data rate adjustment module to monitor network traffic traveling in both uphole and downhole directions. The data rate adjustment module is configured to optimize network settings and efficiency by adjusting the allocation of available network bandwidth for data traffic traveling uphole and downhole.

### U.S. GOVERNMENT INTEREST

This invention was made with government support under Contract No. DE-FC26-01NT41229 awarded by the U.S. Department of Energy. The government has certain rights in the invention.

### BACKGROUND OF THE INVENTION

1. Field of the Invention

This invention relates to oil and gas drilling, and more particularly to apparatus and methods for adjusting the allocation of bandwidth in downhole drilling networks.

2. Background

The goal of accessing data from a drill string has been expressed for more than half a century. As exploration and drilling technology has improved, this goal has become more important in the industry for successful oil, gas, and geothermal well exploration and production. For example, to take advantage of the several advances in the design of various tools and techniques for oil and gas exploration, it would be beneficial to have real time data such as temperature, pressure, inclination, salinity, etc. Several attempts have been made to devise a successful system for accessing such drill string data. However, due to the complexity, expense, and unreliability of such systems, many attempts to create such a system have failed to achieve significant commercial acceptance.

In U.S. Pat. No. 6,670,880 issued to Hall et al., the inventors disclosed a “downhole transmission system” that overcomes many of the problems and limitations of the prior art. In that system, data is transmitted in real time along the drill string by way of a network integrated into the drill string. Tools and sensors located downhole along the drill string communicate in real time with the surface through the network. Data gathered by downhole devices may be analyzed at the surface, and control signals may also be transmitted downhole to the devices.

Because the downhole devices may be primarily responsible for data gathering, data transmitted uphole may be typically significantly greater than data transmitted downhole. Thus, most of the bandwidth or data transmission capability may be reserved for uphole transmission. Nevertheless, data transmitted downhole may occasionally exceed the amount of data that is transmitted uphole. For example, in some cases, relatively large quantities of data may be needed to reprogram downhole devices or to dynamically control such devices. If the downhole bandwidth is disproportionately smaller than the uphole bandwidth, downhole data rates may be undesirably slow. On the other hand, bandwidth reserved for uphole transmissions may go unused. Thus, bandwidth may occasionally be inefficiently allocated to uphole and downhole data traffic.

Thus, what are needed are apparatus and methods to efficiently allocate bandwidth to uphole and downhole data transmission to adjust for differing rates or quantities of data that may travel uphole or downhole.

What are further needed are apparatus and methods to efficiently allocate time intervals in time-division multiplexed systems.

What are further needed are apparatus and methods to efficiently allocate frequencies or channels to uphole and downhole transmission in frequency-multiplexed systems.

### SUMMARY OF THE INVENTION

In view of the foregoing, apparatus and methods in accordance with the invention are directed to efficiently allocating bandwidth to uphole and downhole data transmission by adjusting for differing rates or quantities of data that may travel uphole or downhole. In time-division multiplexed systems, apparatus and methods in accordance with the invention may be used to efficiently allocate time intervals dedicated to uphole and downhole data transmission. In frequency-division multiplexed systems, apparatus and methods in accordance with the invention may be used to efficiently allocate frequencies or channels to uphole and downhole data transmission.

Consistent with the foregoing, and in accordance with the invention as embodied and broadly described herein, a method for adjusting the uphole and downhole data rates of a downhole drilling network is disclosed in one embodiment of the present invention as including allocating a downhole bandwidth to data transmitted from the surface to downhole components, allocating an uphole bandwidth to data transmitted from downhole components to the surface, and increasing the downhole bandwidth in response to an increased quantity of data transmitted from the surface to downhole components.

In selected embodiments, the uphole and downhole bandwidths are allocated from a substantially fixed amount of available bandwidth. In some cases, the available bandwidth may be divided into several channels. The downhole bandwidth, under normal operating conditions, may use a certain number of the channels. When an increase in downhole bandwidth is desired, the number of channels used for downhole transmission may be increased. In selected embodiments, each channel corresponds to a different frequency in the available bandwidth. In other embodiments, the downhole bandwidth may simply be a selected time interval for transmitting data from the surface to downhole components, and the uphole bandwidth may be a second time interval for transmitting data from downhole components to the surface. Under this system, when an increase in the downhole bandwidth is desired, the downhole time interval may be increased and the uphole time interval may be decreased.

In another aspect of the invention, an apparatus for adjusting the data rates between the surface and downhole drilling components may include a downhole network comprising a plurality of nodes. A downhole bandwidth is dedicated to data transmitted along the downhole network from the surface to downhole components. An uphole bandwidth is dedicated to data transmitted along the downhole network from downhole components to the surface. The downhole network is configured to include a data rate adjustment module that increases the downhole bandwidth in response to an increased quantity of data transmitted from the surface to downhole components.

In selected embodiments, the uphole and downhole bandwidths are allocated from a substantially fixed amount of available bandwidth. The available bandwidth may be divided into several channels, with some channels being dedicated to uphole bandwidth and others to downhole bandwidth. To increase the downhole bandwidth, the number of channels used for downhole transmission may be increased.

In selected embodiments, each channel transmits data at a different frequency in the available bandwidth. In other embodiments, the downhole bandwidth is divided up into a downhole time interval for transmitting data from the surface to downhole components, and an uphole time interval for transmitting data from downhole components to the surface. When an increase in the downhole bandwidth is desired, the downhole time interval is increased and the uphole time interval is decreased.

In another aspect of the invention, an apparatus for dynamically adjusting data rates between the surface and downhole drilling components includes a downhole network comprising a plurality of nodes. A downhole time interval is allocated to transmit data along the downhole network from the surface to downhole components. An uphole time interval is allocated to transmit data along the downhole network from downhole components to the surface. The downhole network is further configured to include a data rate adjustment module to increase the downhole time interval in response to an increased quantity of data transmitted from the surface to downhole components.

In selected embodiments, the data rate adjustment module is further configured to decrease the uphole time interval in response to an increased quantity of data transmitted from the surface to downhole components. In other embodiments, the data rate adjustment module is configured to dynamically adjust the uphole and downhole time intervals in accordance with the amount of data that is transmitted in each direction along the downhole network.

### BRIEF DESCRIPTION OF THE DRAWINGS

The foregoing and other features of the present invention will become more fully apparent from the following description, taken in conjunction with the accompanying drawings. Understanding that these drawings depict only typical embodiments in accordance with the invention and are, therefore, not to be considered limiting of its scope, the invention will be described with additional specificity and detail through use of the accompanying drawings in which:

FIG. 1 is a profile view of one embodiment of a drill rig and drill string in accordance with the invention;

FIG. 2 is a schematic diagram illustrating one embodiment of a downhole network in accordance with the invention, integrated into the drill string;

FIG. 3 is a schematic block diagram illustrating various types of hardware and software modules that may be included in a network node in accordance with the invention;

FIG. 4 is schematic block diagram of one embodiment of a data rate adjustment module in accordance with the invention;

FIG. 5A is a schematic block diagram illustrating one embodiment of network bandwidth allocated for uphole and downhole data transmission;

FIG. 5B is a schematic block diagram illustrating one embodiment of network bandwidth re-allocated in response to a change in demand for uphole and downhole bandwidth;

FIG. 6A is a schematic block diagram illustrating one embodiment of network bandwidth divided into channels or frequencies, wherein the uphole and downhole bandwidths use a selected allocation of channels;

FIG. 6B is a schematic block diagram illustrating one embodiment of network bandwidth divided up into channels or frequencies, wherein the uphole and downhole bandwidths are re-allocated or adjusted to use a different number of channels;

FIG. 7A is a schematic block diagram illustrating one embodiment of network bandwidth divided up into time intervals for uphole and downhole data transmission;

FIG. 7B is a schematic block diagram illustrating one embodiment of network bandwidth re-allocated into different time intervals in response to a changed demand for uphole and downhole bandwidth;

FIG. 8 is a schematic block diagram illustrating one embodiment of a downhole network interfacing with various tools and sensors;

FIG. 9 is a schematic block diagram illustrating one embodiment of hardware and software components that may be included in a network node in accordance with the invention; and

FIG. 10 is a schematic block diagram illustrating one embodiment of a network packet in accordance with the invention.

### DETAILED DESCRIPTION OF THE INVENTION

It will be readily understood that the components of the present invention, as generally described and illustrated in the Figures herein, could be arranged and designed in a wide variety of different configurations. Thus, the following more detailed description of embodiments of apparatus and methods of the present invention, as represented in the Figures, is not intended to limit the scope of the invention, as claimed, but is merely representative of various selected embodiments of the invention.

The illustrated embodiments of the invention will be best understood by reference to the drawings, wherein like parts are designated by like numerals throughout. Those of ordinary skill in the art will, of course, appreciate that various modifications to the apparatus and methods described herein may easily be made without departing from the essential characteristics of the invention, as described in connection with the Figures. Thus, the following description of the Figures is intended only by way of example, and simply illustrates certain selected embodiments consistent with the invention as claimed herein.

Many of the functional units described in this specification have been labeled as modules, in order to more particularly emphasize their implementation independence. For example, modules may be implemented in software for execution by various types of processors. An identified module of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. For example, a module of executable code could be a single instruction, or many instructions, and may even be distributed over several different code segments, among different programs, and across several memory devices.

Modules may also be implemented in hardware as electronic circuits comprising custom VLSI circuitry, off-the-shelf semiconductors such as logic chips, transistors, or other discrete components. A module may also be implemented in programmable hardware devices such as field programmable gate arrays, programmable array logic, programmable logic devices, or the like. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

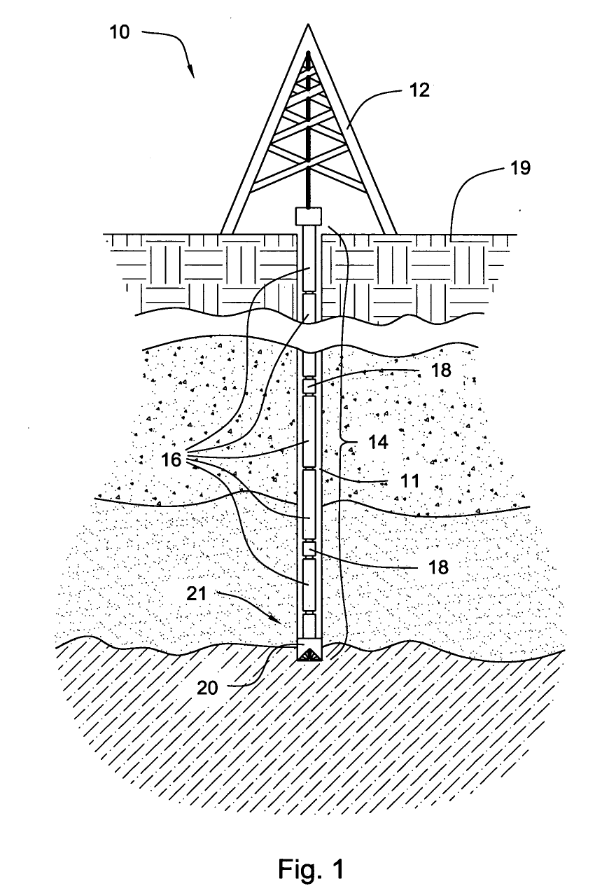

Referring to FIG. 1, a drill rig 10 may include a derrick 12 and a drill string 14 comprised of multiple sections of drill pipe 16 and other downhole tools 16. The drill string 14 is typically rotated by the drill rig 10 to turn a drill bit 20 that is loaded against the earth 19 to form a borehole 11. Rotation of the drill bit 20 may alternately be provided by other downhole tools such as drill motors, or drill turbines (not shown) located adjacent to the drill bit 20.

A bottom-hole assembly 21 may include a drill bit 20, sensors, and other downhole tools such as logging-while-drilling (“LWD”) tools, measurement-while-drilling (“MWD”) tools, diagnostic-while-drilling (“DWD”) tools, or the like. Other downhole tools may include heavyweight drill pipe, drill collar, stabilizers, hole openers, sub-assemblies, under-reamers, rotary steerable systems, drilling jars, drilling shock absorbers, and the like, which are all well known in the drilling industry.

While drilling, a drilling fluid is typically supplied under pressure at the drill rig 10 through the drill string 14. The drilling fluid typically flows downhole through the central bore of the drill string 14 and then returns uphole to the drill rig 10 through the annulus 11. Pressurized drilling fluid is circulated around the drill bit 20 to provide a flushing action to carry the drilled earth cuttings to the surface.

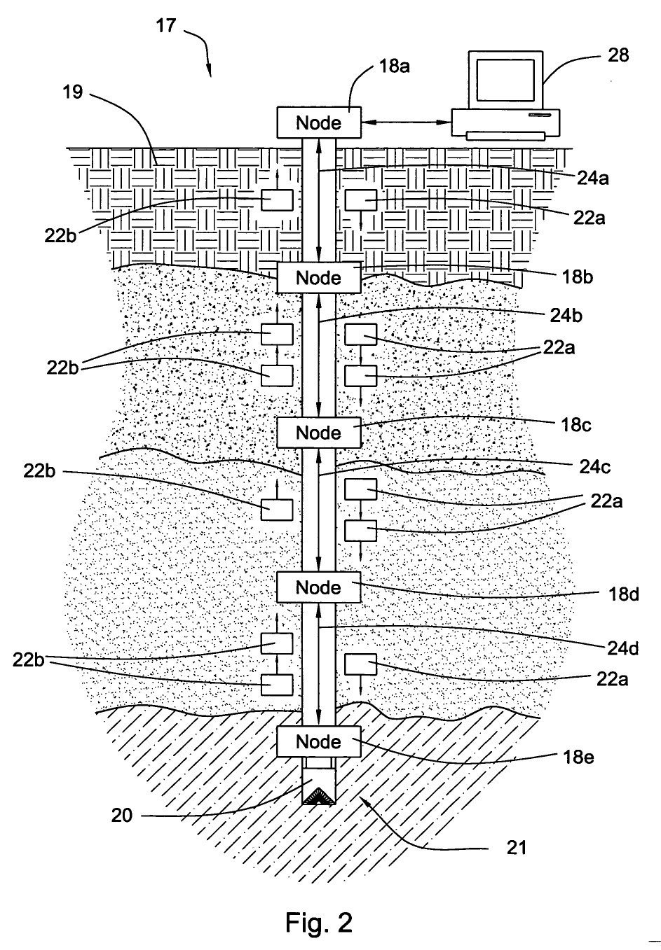

Referring to FIG. 2, while continuing to refer generally to FIG. 1, in selected embodiments, a downhole network 17 may be used to transmit information along the drill string 14. The downhole network 17 may include multiple nodes 18a-e spaced at desired intervals along the drill string 14. The nodes 18a-e may be intelligent computing devices 18a-e, such as routers, or may be less intelligent connection devices, such as hubs, switches, repeaters, or the like, located along the length of the network 17. Each of the nodes 18 may or may not have a network address. A node 18e may be located at or near the bottom hole assembly 21. The bottom hole assembly 21 may include a drill bit 20, drill collar, and other downhole tools and sensors designed to gather data, perform various functions, or the like.

Other intermediate nodes 18b-d may be located or spaced along the network 17 to act as relay points for signals traveling along the network 17 and to interface to various tools or sensors located along the length of the drill string 14. Likewise, a top-hole node 18a may be positioned at the top or proximate the top of the drill string 14 to interface to an analysis device 28, such as a personal computer 28. Communication links 24a-d may be used to connect the nodes 18a-e to one another. The communication links 24a-d may consist of cables or other transmission media integrated directly into the tools 16 comprising the drill string 14, routed through the central bore of the drill string 14, or routed externally to the drill string 14. Likewise, in certain embodiments, the communication links 24a-d may be wireless connections. In selected embodiments, the downhole network 17 may function as a packet-switched or circuit-switched network 17.

To transmit data along the drill string 14, packets 22a, 22b may be transmitted between the nodes 18a-e. The packets 22b may carry data gathered by downhole tools or sensors to uphole nodes 18a, or may carry protocols or data necessary to the function of the network 17. Likewise, some packets 22a may be transmitted from uphole nodes 18a to downhole nodes 18b-e. For example, these packets 22a may be used to carry control signals or programming data from a top-hole node 18a to tools or sensors interfaced to various downhole nodes 18b-e. Thus, a downhole network 17 may provide a high-speed means for transmitting data and information between downhole components and devices located at or near the earth's surface 19.

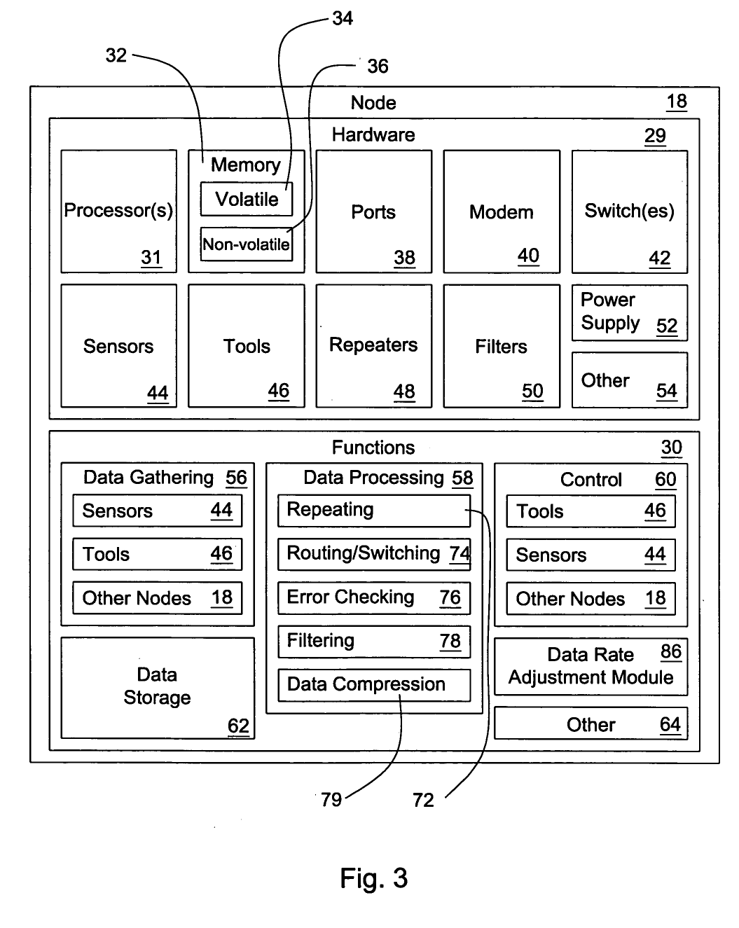

Referring to FIG. 3, a network node 18 in accordance with the invention may include a combination of hardware 29 and software providing various functions 30. The functions 30 may be provided strictly by the hardware 29, software executable on the hardware 29, or a combination thereof. For example, hardware 29 may include one or several processors 31 capable of processing data as well as executing instructions. The processor 31 or processors 31 may include hardware such as busses, clocks, cache, or other supporting hardware.

Likewise, the hardware 29 may include volatile 34 and non-volatile 36 memories 32 to store data and provide staging areas for data transmitted between hardware components 29. Volatile memory 34 may include random access memory (RAM), or equivalents thereof, providing high-speed memory storage. Memory 32 may also include selected types of non-volatile memory 36 such as read-only-memory (ROM), PROM, EEPROM, or the like, or other long-term storage devices, such as hard drives, floppy disks, flash memory, or the like. Ports 38 such as serial ports, parallel ports, or the like may be used to interface to other devices connected to the node 18, such as various sensors or tools located proximate the node 18.

A modem 40 may be used to modulate digital data onto an analog carrier signal for transmission over network cable or other transmission media, and likewise, demodulate the analog signals when received. A modem 40 may include various built in features including but not limited to error checking, data compression, or the like. In addition, the modem 40 may use any suitable modulation type such as ASK, PSK, QPSK, OOK, PCM, FSK, QAM, PAM, PPM, PDM, PWM, or the like, to name a few. The choice of a modulation type may depend on a desired data transmission speed, the bandwidth capability of the network hardware, as well as unique operating conditions that may exist in a downhole environment. Likewise, the modem 40 may be configured to operate in full-duplex, half-duplex, or other mode. The modem 40 may also use any of numerous networking protocols currently available, such as collision-based protocols like Ethernet, token-based, or asynchronous transfer (ATM) protocols.

A node 18 may also include one or several switches 42, multiplexers 42, or both. A switch 42 may filter, forward, and route traffic on the network. Multiplexers 42 (and corresponding demultiplexers 42) may transmit multiple signals over a single communications line or a single channel. The multiplexers 42 may use any known protocol to transmit information over the network 17, including but not limited to frequency-division multiplexing, time-division multiplexing, statistical time-division multiplexing, wave-division multiplexing, code-division multiplexing, spread spectrum multiplexing, or a combination thereof.

A node 18 may also include various downhole tools 46 and sensors 44. These tools 46 and sensors 44 may be integrated into the node 18 (i.e. share the same circuitry) or interface to the node 18 through ports 38. Tools 46 and sensors 44 may include devices such as coring tools, mud logging devices, pore fluid sensors, resistivity sensors, induction sensors, sonic devices, radioactivity sensors, electrical potential tools, temperature sensors, accelerometers, imaging devices, seismic devices, mechanical devices such as caliper tools or free point indicators, pressure sensors, inclinometers, surveying tools, navigation tools, or the like. These tools 46 and sensors 44 may be configured to gather data for analysis uphole, and may also receive data such as control signals, programming data, or the like, from uphole sources. For example, control signals originating at the surface may direct a sensor 44 to take a desired measurement. Likewise, selected tools 46 and sensors 44 may be re-programmed through the network 17 without extracting the tools from the borehole.

A drill string 14 may extend into the earth 20,000 feet or more. As such, signal loss or attenuation may be a significant factor when transmitting data along the downhole network 17. This signal loss or attenuation may vary according to the network hardware. The reader is referred to U.S. Pat. No. 6,670,880 to Hall et al., incorporated herein by reference, for a description of one embodiment of various hardware components used to construct the network 17. For example, a drill string 14 is typically comprised of multiple segments of drill pipe 16 or other drill tools 16. As such, signal loss may occur each time a signal is transmitted from one downhole tool 16 to another 16. Since a drill string may include several hundred sections of drill pipe 16 or other tools 16, the aggregate attenuation can be significant. Likewise, attenuation may also occur in the cable or other transmission media routed along the drill string 14.

To compensate for signal attenuation, amplifiers 48, or repeaters 48, may be spaced at selected intervals along the network 17. The amplifiers 48 may receive a data signal, amplify it, and transmit it to the next node 18. Like amplifiers 48, repeaters 48 may be used to receive a data signal and retransmit it at higher power. However, unlike amplifiers 48, repeaters 48 may remove noise from the data signal. This may be done by demodulating the data from the transmitted signal and re-modulating it onto a fresh carrier.

Likewise, a node 18 may include various filters 50. Filters 50 may be used to filter out undesired noise, frequencies, and the like that may be present or introduced into a data signal traveling up or down the network 17. Likewise, the node 18 may include a power supply 52 to supply power to any or all of the hardware 29. The node 18 may also include other hardware 54, as needed, to provide other desired functionality to the node 18.

The node 18 may provide various functions 30 that are implemented by software, hardware, or a combination thereof. For example, the node's functions 30 may include data gathering 56, data processing 58, control 60, data storage 62, or other functions 64. Data may be gathered 56 from sensors 44 located downhole, tools 46, or other nodes 18 in communication with a selected node 18. This data 56 may be transmitted or encapsulated within data packets transmitted up and down the network 17.

Likewise, the node 18 may provide various data processing functions 58. For example, data processing may include data amplification 72 or repeating 72, routing 74 or switching 74 data packets transmitted along the network 17, error checking 76 of data packets transmitted along the network 17, filtering 78 of data, as well as data compression 79 and decompression 79. Likewise, a node 18 may process various control signals 60 transmitted from the surface to tools 46, sensors 44, or other nodes 18 located downhole. Likewise, a node 18 may store data that has been gathered from tools 46, sensors 44, or other nodes 18 within the network 17. Likewise, the node 18 may include other functions 64, as needed.

In selected embodiments, a node 18 may include a data rate adjustment module 86. The data rate adjustment module 86 may monitor network traffic traveling in both uphole and downhole directions. The data rate adjustment module 86 may optimize the network's settings and efficiency by adjusting the allocation of bandwidth for data traveling uphole and downhole. As is typical in most communication systems, data rates may be limited by the available bandwidth of a particular system. For example, in downhole drilling systems, available bandwidth may be limited by the transmission cable, hardware used to communicate across tool joints, electronic hardware in the nodes 18, the downhole environment, or the like. Thus, the data rate adjustment module 86 may efficiently allocate the limited available bandwidth where it is most needed.

For example, in selected embodiments, most of the network traffic may flow from downhole tools 46 and sensors 44 to the surface for analysis. Thus, ordinarily, most of the network bandwidth may be allocated to traffic traveling uphole. Nevertheless, in some circumstances, more bandwidth may be needed for traffic traveling downhole. For example, in some cases, significant downhole bandwidth may be needed when reprogramming downhole tools 46 and sensors 44, or when sending large amounts of control data downhole. In these instances, the data rate adjustment module 86 may adjust the bandwidth to provide additional bandwidth to downhole traffic. In some instances, this may include reducing the allocated bandwidth for uphole traffic. Likewise, when the need for additional downhole bandwidth has abated, the data rate adjustment module 86 may readjust the available bandwidth by re-allocating bandwidth to uphole traffic.

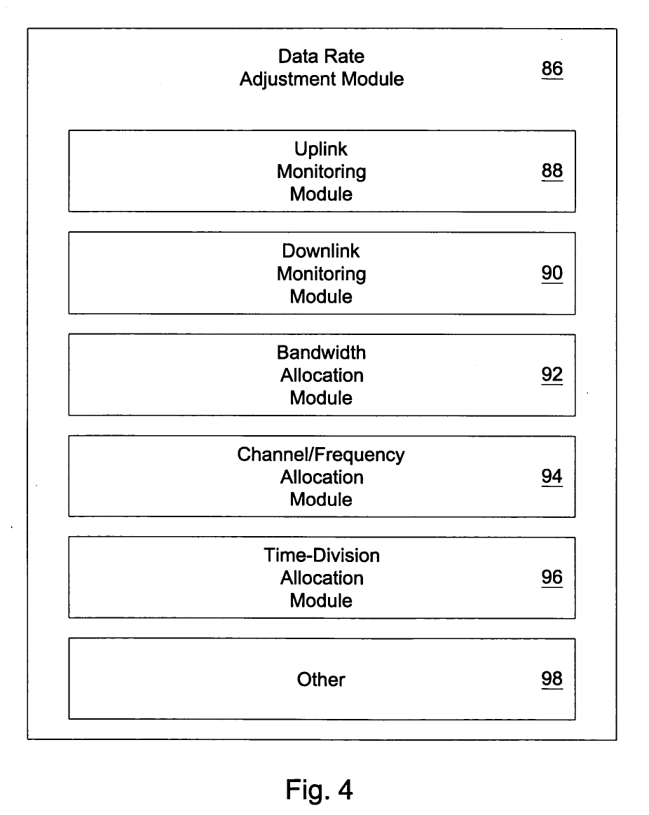

Referring to FIG. 4, for example, is selected embodiments, a data rate adjustment module 86 may include several modules, such as an uplink monitoring module 88, a downlink monitoring module 90, a bandwidth allocation module 92, a channel/frequency allocation module, a time-division allocation module 96, and other modules 98. The functionality of the modules 86, 88, 90, 92, 94, 96, 98 may be provided by any or all of the network nodes 18, or by computers 28 or other hardware 28 located at the surface. An uplink monitoring module 88 may monitor the network's data traffic from downhole nodes 18 to the surface. In selected embodiments, the uphole network traffic may be monitored only at a node 18 or nodes 18 near the surface, or alternatively, uphole network traffic may be monitored at each node in the network 17 to determine where most of the traffic is originating and to determine where additional bandwidth is needed.

Likewise, a downlink monitoring module 90 may monitor network traffic traveling downhole. Likewise a bandwidth monitoring module 92 may efficiently allocate network resources and bandwidth according to the traffic monitored by the uplink and downlink monitoring modules 88, 90. This may include allocating more network bandwidth to downhole traffic, when needed, and reducing allocated bandwidth to uphole traffic, and vice versa.

In selected embodiments, a channel/frequency allocation module 94 may allocate bandwidth by dedicating particular channels or frequencies to uphole and downhole traffic. For example, in frequency-multiplexed systems, certain channels or frequencies may be allocated to downhole traffic, while other channels or frequencies may be allocated to uphole traffic. If more bandwidth is needed in either the uphole or downhole directions, the channel/frequency allocation module may re-allocate particular frequencies or channels from uphole to downhole use or vice versa.

Similarly, in selected embodiments, a time-division allocation module 96 may allocate bandwidth by adjusting time intervals dedicated to uphole and downhole traffic. For example, in time-division multiplexed systems, certain time intervals or divisions may be dedicated to downhole traffic, while other time intervals or divisions may be dedicated to uphole traffic. If more bandwidth is needed in either the uphole or downhole directions, the time-division allocation module 96 may increase the time allocated to uphole or downhole traffic, respectively. In selected embodiments, the channel/frequency allocation module 94 and time-division allocation module 96 may work together in systems that use a combination of time-division and frequency-division multiplexing.

Likewise, the data rate adjustment module 86 may include other modules 98, as needed, to efficiently handle network traffic. For example, in other embodiments, other modules 98 may be used to efficiently allocate network resources in code-division multiplexing systems, spread spectrum transmission systems, statistical time-division multiplexing systems, or combinations thereof.

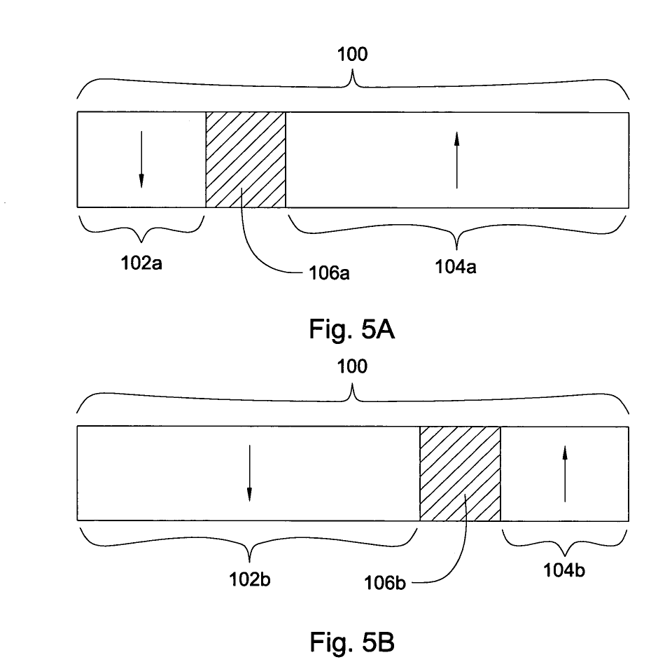

Referring to FIGS. 5A and 5B, for example, in selected embodiments, a network 17 may be limited to an available bandwidth 10. Because most of the network traffic may flow from downhole nodes 18 or components to the surface, most of the available bandwidth 100 may be allocated to uphole traffic. This may be represented as an uphole bandwidth 104a. Likewise, a smaller allocation of bandwidth 100 may be dedicated to downhole traffic, represented by downhole bandwidth 102a. In selected embodiments, an unused band 106a may be provided between the downhole and uphole bands 102a, 104a to prevent interference between uphole and downhole signals.

Nevertheless, in selected embodiments, when more downhole bandwidth is needed to accommodate an increase in downhole traffic, the data rate adjustment module 86 may re-allocate the available bandwidth 100 such that an augmented bandwidth 102b is provided for downhole traffic and a reduced bandwidth 104b is used for uphole traffic. Likewise, the unused band 106b may be shifted to provide a desired separation between the uphole and downhole bands 102b, 104b. In selected embodiments, the uphole and downhole bands 102b, 104b may be adjusted dynamically to most efficiently accommodate differing rates of uphole and downhole traffic.

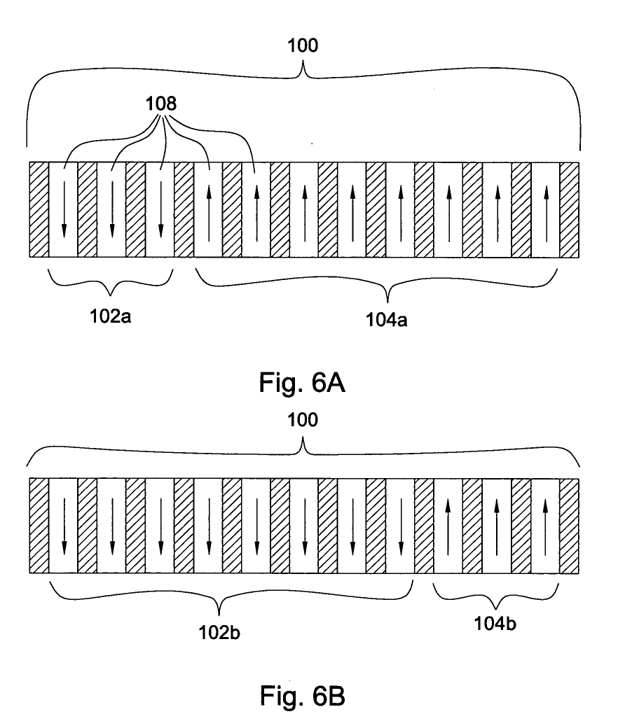

Referring to FIGS. 6A and 6B, in another embodiment, the available bandwidth may be divided into multiple channels 108 or frequencies 108. Such a division may be typical in frequency-division multiplexed schemes or in combination time and frequency-division multiplexed schemes. In such embodiments, selected channels 102a or frequencies 102a may be dedicated to downhole traffic, while other channels 104a or frequencies 104a may be dedicated to uphole traffic. When additional bandwidth is needed for downhole traffic, the data rate adjustment module 86 may re-allocate the available bandwidth 100 such that additional frequencies 108 or channels 108 are used for downhole traffic, providing an augmented downhole bandwidth 102band a reduced uphole bandwidth 104b. In selected embodiments, the frequencies 108 or channels 108 may be adjusted dynamically to most efficiently accommodate differing rates of uphole and downhole traffic.

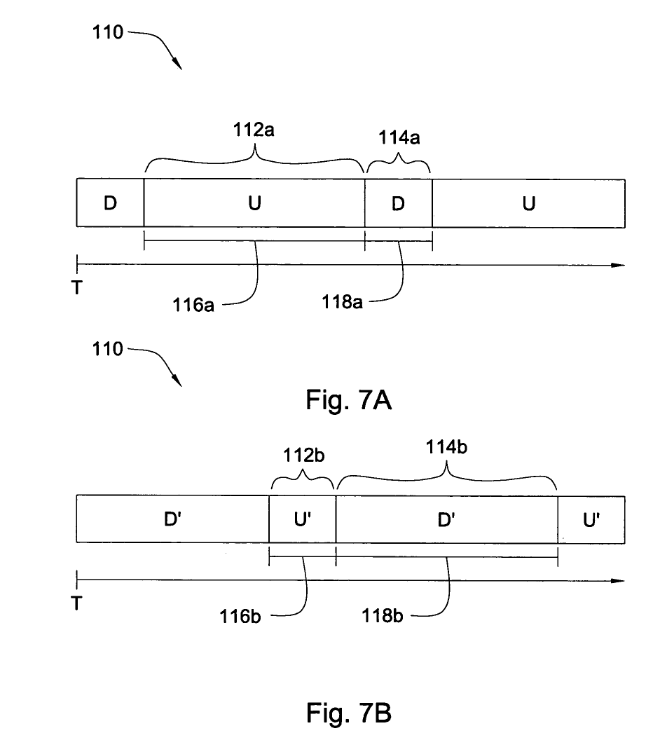

Referring to FIGS. 7A and 7B, in another embodiment, the network bandwidth 110 may be divided up into time increments 112a, 114a or intervals 112a, 114a, having corresponding lengths 116a, 118a, respectively, dedicated to uphole and downhole traffic. This type of bandwidth allocation may be typical in time-division or statistical time-division multiplexing schemes. Since uphole traffic may usually exceed downhole traffic, a longer time interval 112a may be allocated for uphole traffic, whereas a shorter interval 114a may be dedicated to downhole traffic. When additional bandwidth is need to accommodate an increase in downhole traffic, the data rate adjustment module 86 may shorten the uphole time interval 112b and lengthen the downhole time interval 114b to accommodate the change in traffic or demand for bandwidth.

In selected embodiments, these time intervals 112a, 114b may be adjusted dynamically to most efficiently accommodate differing rates of uphole and downhole traffic. Also since, different multiplexing schemes may use a combination of the data transmission techniques described in FIGS. 5A, 5B, 6A, 6B, 7A, and 7B, one of ordinary skill in the art will recognize that the principals taught herein may be modified to work with different types of multiplexing and transmission techniques. Likewise, the principles of bandwidth adjustment taught herein may also be used in other types of multiplexing schemes, including but not limited to code-division multiplexing, spread spectrum multiplexing, or the like.

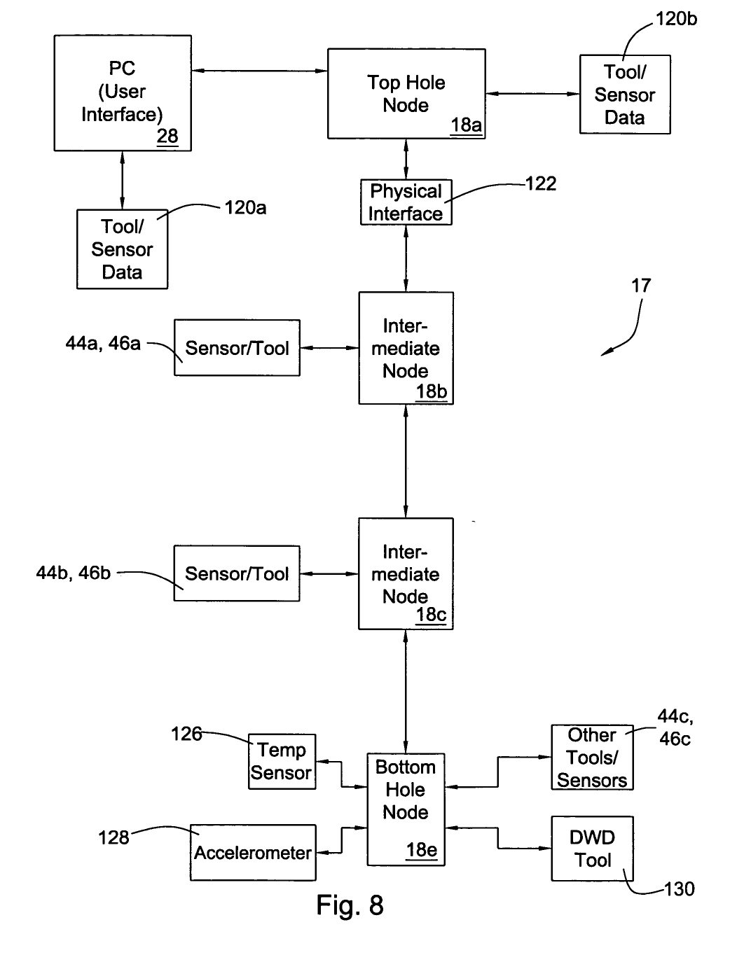

Referring to FIG. 8, in one embodiment, a downhole network 17 in accordance with the invention may include a top-hole node 18a and a bottom-hole node 18e. A bottom-hole node 18e may interface to various components located in or proximate a bottom-hole assembly 21. For example, a bottom-hole node 18e may interface to a temperature sensor 126, an accelerometer 128, a DWD (diagnostic-while-drilling) tool 130, or other tools 46c or sensors 44c such as those listed in the description of FIG. 3.

A bottom-hole node 18e may communicate with an intermediate node 18c located at an intermediate point along the drill string 14. The intermediate node 18c may also provide an interface to tools 46b or sensors 44b communicating through the network 17. Likewise, other nodes 18, such as a second intermediate node 18b, may be located along the drill string 14 to communicate with other sensors 44a or tools 46a. Any number of intermediate nodes 18b, 18c may be used along the network 17 between the top-hole node 18a and the bottom-hole node 18e.

In selected embodiments, a physical interface 122 may be provided to connect network components to a drill string 14. For example, since data may be transmitted directly up the drill string on cables or other transmission media integrated directly into drill pipe 16 or other drill string components 16, the physical interface 122 may provide a physical connection to the drill string so data may be routed off of the drill string 14 to network components, such as a top-hole node 18a, or personal computer 28.

For example, a top-hole node 18a may be operably connected to the physical interface 122. The top-hole node 18a may also be connected to an analysis device 28 such as a personal computer 28. The personal computer 28 may be used to analyze or examine data gathered from various downhole tools 46 or sensors 44. Likewise, tool and sensor data 120a may be saved or output from the personal computer 28. Likewise, in other embodiments, tool and sensor data 120b may be extracted directly from the top-hole node 18a for analysis.

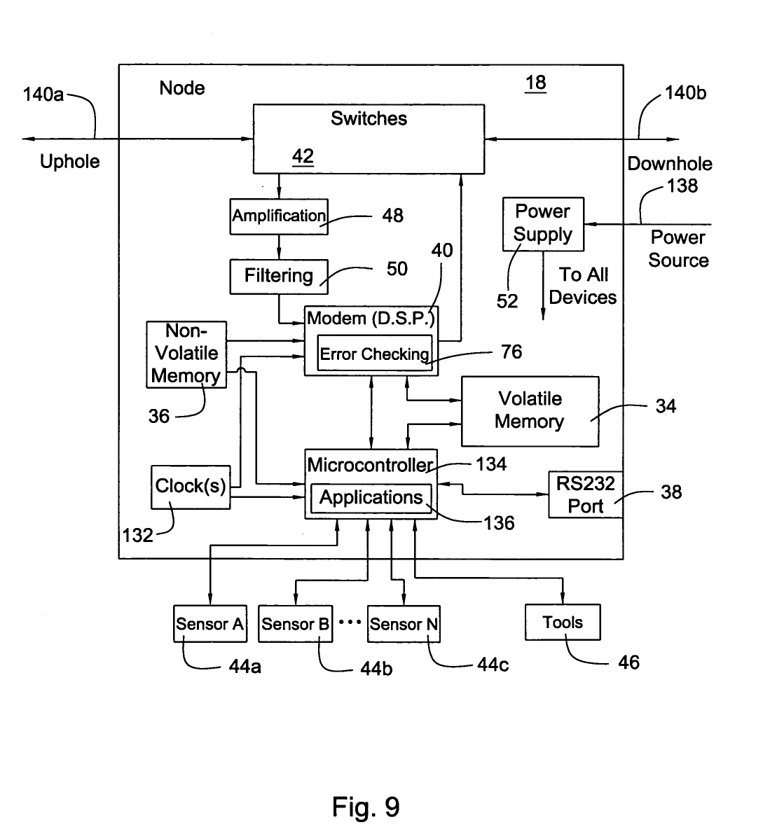

Referring to FIG. 9, in selected embodiments, a node 18 may include various components to provide desired functionality. For example switches 42, multiplexers 42, or a combination thereof may be used to receive, switch, and multiplex or demultiplex signals, received from other uphole 140a and downhole 140b nodes 18. The switches/multiplexers 42 may direct traffic such as data packets or other signals into and out of the node 18, and may ensure that the packets or signals are transmitted at proper time intervals, frequencies, or combinations thereof.

In certain embodiments, the multiplexer 42 may transmit several signals simultaneously on different carrier frequencies. In other embodiments, the multiplexer 42 may coordinate the time-division multiplexing of several signals. Signals or packets received by the switch/multiplexer 42 may be amplified 48 and filtered 50, such as to remove noise. In certain embodiments received signals may simply be amplified 48. In other embodiments, the signals may be received, data may be demodulated therefrom and stored, and the data may be remodulated and retransmitted on a selected carrier frequency having greater signal strength. A modem 40 may be used to demodulate digital data from signals received from the switch/multiplexer and modulate digital data onto carrier signals for transfer to the switches/multiplexer for transmission uphole or downhole

The modem 40 may also perform various tasks such as error-checking 76 and data compression. The modem 40 may also communicate with a microcontroller 134. The microcontroller 134 may execute any of numerous applications 136. For example, the microcontroller 134 may run applications 136 whose primary function is acquire data from one or a plurality of sensors 44a-c. For example, the microcontroller 134 may interface to sensors 44 such as inclinometers, thermocouplers, accelerometers, imaging devices, seismic data gathering devices, or other sensors such as those listed in the description of FIG. 3. Thus, the node 18 may include circuitry to function as a data acquisition tool.

In other embodiments, the microcontroller 134 may run applications 136 that may control various tools 46 or sensors 44 located downhole. That is, not only may the node 18 be used as a repeater, and as a data gathering device, but may also be used to receive or provide control signals to control selected tools 46 and sensors 44 as needed. The node 18 may also include a volatile memory device 34, such as a FIFO 34 or RAM 34, that may be used to store data needed by or transferred between the modem 40 and the microcontroller 134.

Other components of the node 18 may include non-volatile memory 36, which may be used to store data, such as configuration settings, node addresses, system settings, and the like. One or several clocks 132 may be provided to provide clock signals to the modem 40, the microcontroller 134, or any other device. A power supply 52 may receive power from an external power source 138 such as batteries. The power supply 52 may provide power to any or all of the components located within the node 18. Likewise, an RS232 port 38 may be used to provide a serial connection to the node circuit 18.

Thus, the node 18 described in FIG. 6 may provide many more functions than those supplied by a simple signal repeater. The node 18 may provide many of the advantages of an addressable node on a local area network. The addressable node may amplify signals received from uphole 140b or downhole 140a sources, be used as a point of data acquisition, and be used to provide control signals to desired sensors 44 or tools 46. These represent only a few examples of the versatility of the node 18. Thus, the node 18, although useful and functional as a repeater 30, may have a greatly expanded capability.

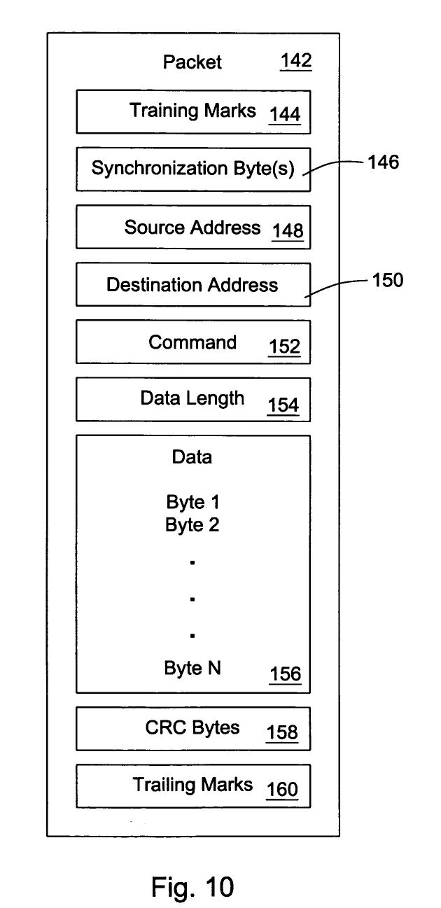

Referring to FIG. 10, a packet 142 containing data, control signals, network protocols, or the like may be transmitted up and down the drill string 14 through the network 17. For example, in one embodiment, a packet 142 in accordance with the invention may include training marks 144. Training marks 144 may include any overhead, synchronization, or other data needed to enable another node 18 to receive a particular data packet 142.

Likewise, a packet 142 may include one or several synchronization bytes 146. The synchronization byte 146 or bytes 146 may be used to synchronize the timing of a node 18 receiving a packet 142. Likewise, a packet 142 may include a source address 148, identifying the logical or physical address of a transmitting device, and a destination address 150, identifying the logical or physical address of a destination node 18 on a network 17.

A packet 142 may also include a command byte 152 or bytes 152 to provide various commands to nodes 18 within the network 17. For example, commands 152 may include commands to set selected parameters, reset registers or other devices, read particular registers, transfer data between registers, put devices in particular modes, acquire status of devices, perform various requests, and the like.

Likewise, a packet 142 may include data or information 154 with respect to the length 154 of data transmitted within the packet 142. For example, the data length 154 may be the number of bits or bytes of data carried within the packet 142. The packet 142 may then include data 156 comprising a number of bytes. The data 156 may include data gathered from various sensors 44 or tools 46 located downhole, or may contain control data to control various sensors 44 or tools 46 located downhole. Likewise one or several bytes 158 may be used to perform error checking of other data or bytes within a packet 142. Trailing marks 160 may provide any other overhead or synchronization needed after transmitting a packet 142. One of ordinary skill in the art will recognize that network packets 142 may take on many forms and contain varied information. Thus, the example presented herein simply represents one contemplated embodiment in accordance with the invention, and is not intended to limit the scope of the invention.

The present invention may be embodied in other specific forms without departing from its essence or essential characteristics. The described embodiments are to be considered in all respects only as illustrative, and not restrictive. The scope of the invention is, therefore, indicated by the appended claims, rather than by the foregoing description. All changes within the meaning and range of equivalency of the claims are to be embraced within their scope.

1. A method for adjusting the uphole and downhole data rates in a downhole drilling network, the method comprising:
allocating a downhole bandwidth to data transmitted from the surface to downhole components;
allocating an uphole bandwidth to data transmitted from downhole components to the surface; and
increasing the downhole bandwidth in response to an increased quantity of data transmitted from the surface to downhole components.

2. The method of claim 1, wherein the uphole and downhole bandwidths are allocated from a substantially fixed amount of available bandwidth.

3. The method of claim 1, wherein the available bandwidth is divided into a plurality of channels.

4. The method of claim 3, wherein the downhole bandwidth uses a select number of the plurality of channels.

5. The method of claim 4, wherein increasing the downhole bandwidth comprises increasing the number of channels used to transmit data from the surface to downhole components.

6. The method of claim 4, wherein each channel corresponds to a different frequency in the available bandwidth.

7. The method of claim 1, wherein:
allocating the downhole bandwidth comprises allocating a first time interval for transmitting data from the surface to downhole components; and
allocating the uphole bandwidth comprises allocating a second time interval for transmitting data from downhole components to the surface.

8. The method of claim 1, wherein increasing the downhole bandwidth comprises increasing the first time interval and decreasing the second time interval.

9. An apparatus for adjusting the data rates between the surface and downhole drilling components, the apparatus comprising:
a downhole network comprising a plurality of nodes;
a downhole bandwidth dedicated to data transmitted along the downhole network from the surface to downhole components;
an uphole bandwidth dedicated to data transmitted along the downhole network from downhole components to the surface; and
the downhole network further configured to include a data rate adjustment module, wherein the data rate adjustment module is configured to increase the downhole bandwidth in response to an increased quantity of data transmitted from the surface to downhole components.

10. The apparatus of claim 9, wherein the uphole and downhole bandwidths are allocated from a substantially fixed amount of available bandwidth.

11. The apparatus of claim 10, wherein the available bandwidth is divided into a plurality of channels.

12. The apparatus of claim 11, wherein the downhole bandwidth uses a select number of the plurality of channels.

13. The apparatus of claim 12, wherein the data rate adjustment module is configured to increase the downhole bandwidth by increasing the number of channels used by the downhole bandwidth.

14. The apparatus of claim 11, wherein each channel corresponds to a different frequency in the available bandwidth.

15. The apparatus of claim 9, wherein:
the downhole bandwidth comprises a first time interval for transmitting data from the surface to downhole components; and
the uphole bandwidth comprises a second time interval for transmitting data from downhole components to the surface.

16. The apparatus of claim 15, wherein the data rate adjustment module is configured to increase the downhole bandwidth by increasing the first time interval and decreasing the second time interval.

17. The apparatus of claim 9, wherein the data rate adjustment module is configured to dynamically adjust the uphole and downhole bandwidths in accordance with the amount of data that is transmitted in each direction along the downhole network.

18. An apparatus for dynamically adjusting the data rates between the surface and downhole drilling components, the apparatus comprising:
a downhole network comprising a plurality of nodes;
a downhole time interval allocated to transmit data along the downhole network from the surface to downhole components;
a uphole time interval allocated to transmit data along the downhole network from downhole components to the surface; and
the downhole network further configured to include a data rate adjustment module, wherein the data rate adjustment module is configured to increase the downhole time interval in response to an increased quantity of data transmitted from the surface to downhole components.

19. The apparatus of claim 18, wherein the data rate adjustment module is further configured to decrease the uphole time interval in response to an increased quantity of data transmitted from the surface to downhole components.

20. The apparatus of claim 18, wherein the data rate adjustment module is configured to dynamically adjust the uphole and downhole time intervals in accordance with the amount of data that is transmitted in each direction along the downhole network.
